(19) United States
(12) Patent Application Publication
(10) Pub. No.: US 2003/0200532 A1
(43) Pub. Date: Oct. 23, 2003

(54) System and method for sharing reusable code base

(76) Inventor: Thomas Gensel, Akron, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/294,285

(22) Filed: Nov. 14, 2002

Related U.S. Application Data
(60) Provisional application No. 60/373,184, filed on Apr. 17, 2002.

(51) Int. Cl. G06F 9/44

(52) U.S. Cl. 717/120; 717/115

(57) ABSTRACT

A system that facilitates sharing a reusable code base that includes genericized, automatically customizable software components is provided. The system includes components for identifying files associated with a build collection, collecting files associated with a build collection, displaying information associated with a build collection and build actions, and performing build actions. The display can be dynamically configured project by project based, at least in part, on information supplied by the project.

### CROSS REFERENCE TO RELATED APPLICATIONS

This application claims the benefit of provisional application 60/373,184 entitled Computer-Implemented System and Method for Building a Software Image, dated Apr. 17, 2002, which is incorporated herein by reference.

### TECHNICAL FIELD

The methods, systems, application programming interfaces (API), graphical user interfaces (GUI), data packets, and computer readable media described herein relate generally to computer programming and more specifically to sharing a reusable code base.

### BACKGROUND

An executable computer project can be built with material and information gathered from a variety of sources. The material and information can include, for example, source files, description files, and logic for combining the files into a computer executable project. For example, a first computer executable project may be built from one source file located on one machine. A second computer executable project might be built from two source files located on two machines and a description file located on a third machine, where one of the two source files references other “include” files. A third computer executable project might be built from dozens of source and description files that reference multiple “include” files, the output of several processes, third party executable files, pre-compiled object files, and so on. These files might be distributed over a large number of computers. Thus, determining which files to collect to build a computer executable project has conventionally been difficult.

As complicated as it is to collect the necessary files to build an executable computer project, merely collecting the files may not be even half the battle. Identifying the files required for a computer project may depend on, for example, the environment in which the computer project will run. While a first set of files may be collected for a first processor (e.g., Intel StrongARM), a second set of files may be collected for a second processor (e.g., Sun SPARC). Furthermore, while a first set of files may be collected for a project that will run on a first operating system (e.g., Windows CE), a second set of files may be collected for a project that will run on a second operating system (e.g., MAC OS X). Thus, with just these two variables (processor, operating system), a person tasked with building a computer executable project will be faced with selecting the “correct” set of files from a daunting set of choices. Furthermore, even after a “correct” file has been selected, it may need to be customized for the processor and/or operating system. While processor and operating system are described as possible environment variables, it is to be appreciated that other variables may also factor into a build collection choice. For example, locality, versioning, security, networking, interface, chip set, and so on may all be variables to consider in a build collection choice.

While making build collection choices has conventionally been a difficult task, deciding what to do with the collected files has also been a complicated matter. Conventionally, the skills, experience, practices, and intuition of an experienced engineer intimately familiar with the project to be built have been required to make sense of the build collection choices and the build collection action(s) to be applied to the collected files. For example, the skilled engineer may know which files should be collected for which environment, in what order they should be compiled (and by which compilers/assemblers), in what order they should be linked, when checks for updates should be made, what output type(s) should be produced, where the output(s) should be delivered, and so on. The engineer may memorize this knowledge or may commit it to paper or a text file, for example. Clearly, keeping track of the different parameters on which build collection choices and build collection actions are made has not been easy.

Thus, several shortcomings identified with conventional systems have been identified. For example, it has typically been difficult to share reusable code between projects. While one project may be aware of which files and actions it requires to be built, the project likely exists in isolation from other projects and thus is not able to benefit by sharing reusable code and/or improvements/updates made to shareable, reusable code. Thus, changes in shareable, reusable code have typically not been propagated between projects in a timely manner.

Similarly, it has typically been difficult to collect software components distributed between different libraries, data stores and so on. The difficulty of collecting components from distributed sources is exacerbated by the variety of files (e.g., reusable software components, project specific components, third party software) that may be included in a build collection. Since the knowledge about collecting and building various projects has typically resided in the consciousness and/or files of an experienced builder (who is frequently very busy), it has been difficult to abstract and extract generic build collection choice logic and build collection action logic. Thus, projects tend not to benefit from experience gained in previous projects concerning file customizations, compilation sequences, file dependencies, and so on.

While there have been some attempts to simplify project building choices, such attempts have typically focused on manually entering information into a standard file (e.g., .Ini file, Windows Registry) that is not flexible between environments (e.g., processors, chip sets, operating systems) and which typically does not configure itself based on a project. Thus, there are opportunities for improvements in sharing reusable code in the project build collection and project build action field.

### SUMMARY

The following presents a simplified summary of methods, systems, APIs, GUIs, data packets, and computer readable media described herein to facilitate providing a basic understanding of these items. This summary is not an extensive overview and is not intended to identify key or critical elements of the methods, systems, APIs, GUIs, data packets, and computer readable media or to delineate the scope of these items. This summary provides a conceptual introduction in a simplified form as a prelude to the more detailed description that is presented later.

This application describes an example system that facilitates sharing a reusable code base. In one example, the shareable, reusable code base is employed to create a project build directory for a computer executable project. One example system includes core source files that are processed into software components of the computer executable project. The system also includes core component files that facilitate identifying core source files associated with the computer executable project and core files that facilitate identifying core component files available to be associated with a computer executable project. The system also includes a project file that facilitates identifying environment parameters associated with the computer executable project, where the environment parameters facilitate identifying a core file and/or a component file to associate with the computer executable project. The project file also facilitates identifying a project specific software component and/or a project specific source file. The system also includes a build collector that collects core source files, project specific source files, software components, and/or project specific software components to populate the project build directory.

The application also describes an example computer executable method that facilitates building a computer executable project from shareable, reusable code. The method includes assembling shareable, reusable software components into a collection of reusable software components, creating a component core file that facilitates selecting a reusable software component for use in populating a project build directory, and creating a core file that facilitates storing associated sets of available core component files. The core file facilitates selecting reusable software components for use in populating a project build directory and also facilitates storing associated sets of core level project build rules. The method also includes creating a project file that facilitates identifying items including, but not limited to, a core file, a component core file, a project specific component, a core level build rule, and a project specific build rule for use in populating a computer build directory. The method also includes creating a project build directory. In one example, the method also includes dynamically configuring a user interface to simplify specifying build collection choices and/or build action choices. In another example, the method also includes building a computer executable project from the build directory.

The application also describes a data packet for transmitting build file information and build logic between computer components associated with the systems and methods described herein. The data packet includes a first field that stores source file identifiers and a second field that stores one or more source file combination rules.

The application also describes an interfacing method employed on a computer system that has a graphical user interface. The GUI includes a display and a selection device. The method facilitates providing and selecting from a set of data entries on the display. The method includes retrieving a set of data entries, where the data entries represent a core logic data, a core logic operation, a project specific data, a project specific logic operation, a third party data, and/or a third party logic operation. The method also includes displaying the set of entries on the display, receiving a data entry selection signal indicative of the selection device selecting a selected data entry, and in response to the data entry selection signal, initiating an operation associated with the selected data entry.

The application also describes a set of application programming interfaces embodied on a computer readable medium for execution by a computer component in conjunction with sharing reusable code. The API includes a first interface for managing a core logic and core data, a second interface for managing a project specific logic and project specific data, and a third interface for managing a third party logic and third party data. The core logic, the core data, the project specific logic, the project specific data, the third party logic, and the third party data are employed in building the computer executable project.

Thus, in one example, the systems and methods described herein relate to a utility that facilitates sharing a reusable code base. The utility facilitates collecting and processing software components distributed between different libraries and data stores. The utility may interact with, for example, core files, program specific files, and third party software. The utility facilitates integrating operating system and application software combinations with board level components and hardware devices.

In another example, knowledge associated with build techniques employed by software engineers in conventional build processes, (e.g., useful collections of files, processes for converting files to an executable computer project) is captured in core files, core component files, project specific files, collection logic, and build logic.

In another example, changes in shared code are propagated more efficiently and in a more timely manner through the dynamic association of core source files with files included in a project build directory. The files included in the project build directory may, for example, maintain the dynamic association with the core files via include statements.

Certain illustrative example methods, systems, APIs, GUIs, data packets, and computer readable media are described herein in connection with the following description and the annexed drawings. These examples are indicative, however, of but a few of the various ways in which the principles of the examples may be employed and thus are intended to be inclusive of equivalents. Other advantages and novel features may become apparent from the following detailed description when considered in conjunction with the drawings.

### BRIEF DESCRIPTION OF THE DRAWINGS

FIG. 1 illustrates an example system for sharing a reusable code base.

FIG. 2 illustrates example relationships between a core file and a core component file.

FIG. 3 illustrates an example tool that facilitates collecting files of shareable, reusable code for building a project and making project building choices.

FIG. 4 is a screen shot of an example GUI associated with systems and methods for sharing a reusable code base.

FIG. 5 is a screen shot of an example GUI associated with systems and methods for sharing a reusable code base.

FIG. 6 is a screen shot of an example GUI associated with systems and methods for sharing a reusable code base.

FIG. 7 is a flow chart of a portion of an example method for sharing a reusable code base.

FIG. 8 is a flow chart of a portion of an example method for sharing a reusable code base.

FIG. 9 illustrates an example data packet transmitted between components of systems and methods employed in sharing a reusable code base.

FIG. 10 is a schematic block diagram of an example computing environment with which the systems, methods, GUIs, APIs, and data packets described herein can be employed.

FIG. 11 illustrates an example API that facilitates employing systems and methods for sharing a reusable code base.

FIG. 12 illustrates an example system for producing a specific hardware platform image.

### DETAILED DESCRIPTION

Example systems, methods, GUIs, APIs, data packets, and computer media are now described with reference to the drawings, where like reference numerals are used to refer to like elements throughout. In the following description, for purposes of explanation, numerous specific details are set forth in order to facilitate thoroughly understanding the examples. It may be evident, however, that the examples can be practiced without these specific details. In other instances, well-known structures and devices are shown in block diagram form in order to simplify description.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Signal”, as used herein, includes but is not limited to one or more electrical or optical signals, analog or digital, one or more computer instructions, a bit or bit stream, or the like.

“Software”, as used herein, includes but is not limited to, one or more computer readable and/or executable instructions that cause a computer or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer component and/or distributed between two or more communicating, co-operating, and/or parallel processing computer components and thus can be loaded and/or executed in serial, parallel, massively parallel, and other manners.

“Software component”, as used herein, includes but is not limited to, a collection of one or more computer readable and/or executable instructions that cause a computer or other electronic device to perform functions, actions and/or behave in a desired manner. The instructions may be embodied in various forms like routines, algorithms, modules, methods, threads, and/or programs. Software components may be implemented in a variety of executable and/or loadable forms including, but not limited to, a stand-alone program, a servelet, an applet, instructions stored in a memory, and the like. Software components can be embodied in a single computer component and/or can be distributed between computer components.

“Logic”, as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

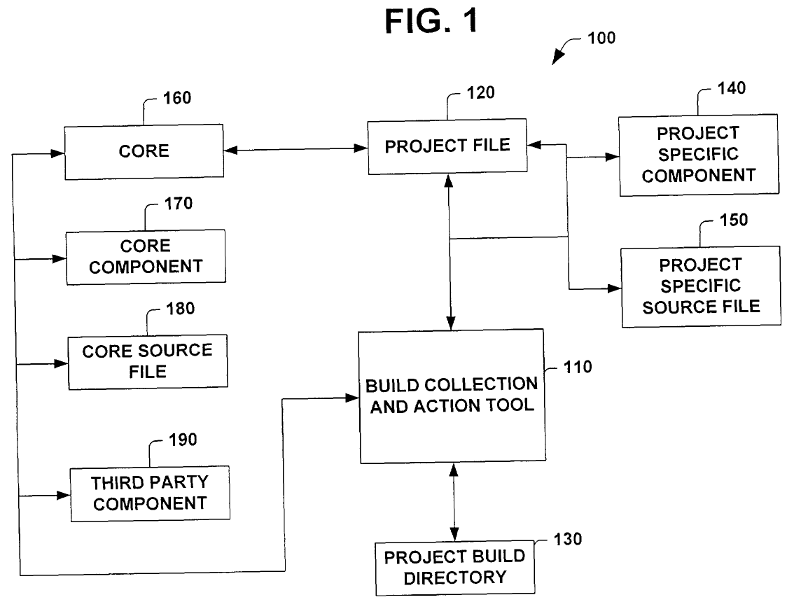

Turning now to FIG. 1, a system 100 that facilitates sharing a reusable code base is illustrated. A build collection and action tool 110 interacts with a project file 120 to facilitate determining which files and/or rules to collect and how to collect the files and/or rules into a project build directory 130. While a single build collection and action tool 110 is illustrated, it is to be appreciated that the tool 110 can be implemented in one computer component and/or can be implemented in two or more communicating, co-operating computer components. In one example, the build collection and action tool 110 is software running on a computer. Similarly, while one project build directory 130 is illustrated, it is to be appreciated that one or more build directories 130 can be created, populated, and/or manipulated by the tool 110.

The tool 110 can be employed to create executable images for internet appliances, for example. Internet appliances (described in greater detail below) can have various hardware components. These various hardware components may benefit from having associated software (e.g., device drivers). Device drivers that service families of related hardware components (e.g., UARTs, keyboards, displays), may share many common characteristics. Thus, it is possible to genericize such device drivers and make them automatically customizable. The tool 110 facilitates identifying appropriate generic customizable device drivers, automatically customizing them, and assembling them into an executable image. Thus, a person who desires an executable image for an internet appliance can use the tool 110 to identify the collection of hardware components in their appliance and to build an executable image for the internet appliance from reusable, genericized, automatically customizable software components like device drivers.

The project file 120 facilitates identifying project specific items like project specific components 140, project specific source files 150, and project specific rules employed in building a project build directory 130 from the files collected for the project. For example, a first project may have generic software components drawn from core source files 180 that are part of a shared, reusable code base but may also have project specific components 140 that are not part of a shared, reusable code base. The generic software components may be customizable based on, for example, information associated with the project components 140.

The project file 120 also facilitates identifying environment parameters associated with a computer executable project. The environment parameters facilitate identifying items unique to a project. These items can include, but are not limited to, a processor, a chip set, an operating system, an operating system version, an interface type, an interface version, a network type, a network version, a remote procedure call mechanism, an object hierarchy, and the like. Thus, the generic software components may also be customizable based on the environment parameters.

The project file 120 can also hold information including, but not limited to, a core file 160 to associate with the computer executable project, a core component file 170 to associate with the computer executable project, a project specific software component 140 to associate with the computer executable project, and a project specific source file 150 to associate with the computer executable project. By specifying information like that described above, the project file 120 facilitates automating sharing a reusable code base when building a computer executable project. Furthermore, by specifying information like that described above, the project file 120 facilitates customizing generic software components retrieved from a shareable, reusable code base.

The project file 120 can also identify items located in a reusable code base. Thus, the project file 120 interacts with a core file 160, a core component 170, core source files 180, and/or third party components 190. The interaction may be direct or indirect using, for example, the core file 160 to achieve indirection. In one example, the project file 120 identifies which core file 160 and/or core components 170 to include in a project.

The system 100 includes one or more core source files 180 that can be processed into software components to include in the computer executable project. The core source files 180 are shareable, reusable code. The source files 180 may be retrieved from a variety of places and may be stored in a variety of formats. By way of illustration, the source files 180 can be conventional source files (e.g., C, C++ code files) stored on a local disk. By way of further illustration, the source files 180 may be provided in other formats (e.g., object, executable, script) from remote locations (e.g., Internet, distributed system, version controlled source code database) using push and/or pull technology. Furthermore, the source files 180 may be the output of a process launched at build time by the build collection and action tool 110. Additionally, and/or alternatively, the source files 180, core component files 170, and/or core files 160 may include XML (Extensible Markup Language) or XML-like statements.

The source files 180 may be, for example, highly generic, highly customizable device drivers. By way of illustration, there may be a generic keyboard device driver that can be customized to support one of a dozen keyboards. The customizations may depend, for example, on the other hardware components with which the keyboard will interact and/or the operating system that will be running. In one example, many customizations can be anticipated and accounted for in the generic driver. Then, when the desired customization is required, the appropriate code in the generic driver can be selected and the inapplicable code can be discarded. The tool 110 facilitates identifying these project parameters (e.g., chip set, operating system) and thus facilitates automatically customizing such a highly generic, highly customizable device driver.

The system 100 includes one or more core component files 170 that facilitate identifying core source files 180 associated with the computer executable project. In one example, there is a core component file 170 for each core source file 180 available for inclusion in a project. For example, a first core source file 180 may be a device driver for a first universal asynchronous receiver/transmitter (UART). In another example, there is an entry in a core component file 170 for each core source file 180. In one example, the core component file 170 may be organized as an XML file. A second core source file 180 may be a device driver for a second UART. A first project may be built on a platform that includes the first UART, and thus a core component file 170 associated with the first core source file 180 would be associated with the project. The first core component file 170 may include, for example, information on how to locate the first core source file 180 and how to customize it based on project specific information. A second project may be built on a platform that includes the second UART, and thus a core component file 170 associated with the second core source file 180 would be associated with the project.

The system 100 includes one or more core files 160 that facilitate identifying core component files 170 available to be associated with a computer executable project. Thus, information concerning a certain class of projects may be aggregated in a core file 160. For example, a certain class of projects may be built on a platform that includes some form of UART. Thus, a core file 160 for that class of project may have core component file 170 entries for each of the available UARTs. Then, when a project file 120 is associated with a core file 160, a specific core source file 180 associated with a specific UART and thus with a specific core component file 170 can be selected. This facilitates sharing reusable code and further facilitates automating project builds.

The system 100 also includes a build collection and action tool 110 for collecting items to populate the project build directory 130. A user of the system 100 can run the tool to pick and/or edit a project file 120. Based on the project file 120, the tool 110 collects items including, but not limited to, a core file 160, one or more core components 170, one or more shareable, reusable core source files 180, one or more third party components 190, one or more project specific components 140, one or more project specific source files 150, and rules for combining the collected items into a build directory 130 and/or a computer executable project. The build collection and action tool 110 applies rules from the project file 120 to identify which files are needed. Then, the tool 110 provides a directory view of a project to facilitate visualizing whether the necessary files have been collected and if so, how a computer executable project built from the collected files would look. The tool 110 thus facilitates building build directories and populating those directories with files that will participate in building the computer executable project.

A project build directory 130 may be constructed from files that support different syntax types associated with linking files. For example, a project build directory 130 may interact with files that support “include” syntax (e.g., C #include statement). Files that support include syntax may maintain a link with a core source file 180 rather than copying the core source file 180 to the build directory 130. Thus, when changes are made to a core source file 180, the change can be propagated efficiently, in a timely manner, to the build directories 130 where a copy of the file and/or a link to the file is located. This facilitates sharing reusable code. This also facilitates customizing generic files (e.g., device drivers), that may be stored in a generic form in the reusable code base and customized based on project specific data.

The project build directory 130 may also interact with files that do not support include syntax. In this case, the build directory 130 may copy a core source file 180 into a build directory 130 rather than establishing a link in the build directory 130 as was the case for files that support include syntax. A project build directory 130 may also interact with files destined for release. For example, after testing and debugging a computer executable project built from a collection of files aggregated in a project build directory 130, a developer may decide to “release” the project. There can be different types of releases. For example, a first release might be binary only, while a second release might be source only, and a third release might be a mix of binary and source. Thus, a project build directory 130 can undertake actions including, but not limited to, copying core source files 180, resolving links to core source files 180, copying binary files, resolving links to binary files, and so on, when engaged in building a computer executable project.

While FIG. 1 illustrates the core 160, core components 170, and core source files 180 as separate and distinct entities, it is to be appreciated that portions of a core file 160, core component 170, and core source file 180 may also, in one example, be intermingled and stored in a project file 120.

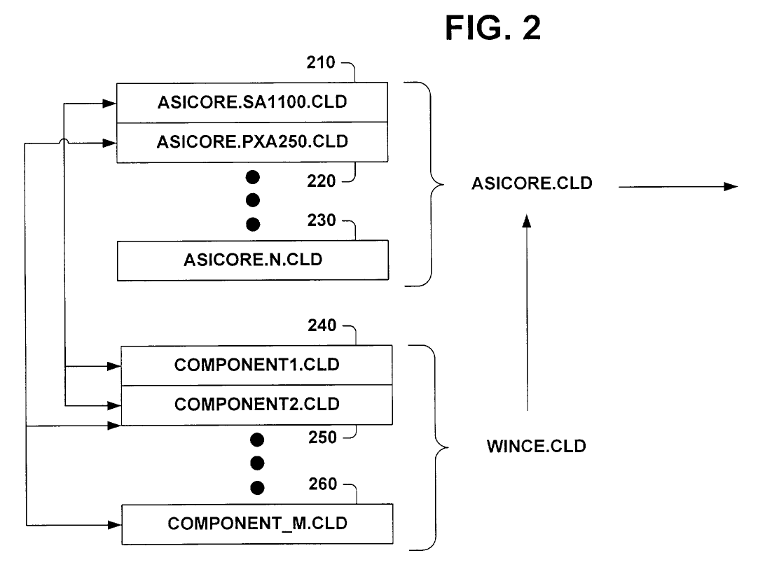

FIG. 2 illustrates example relationships between core files and core component files. A core file stores core-wide rules applicable to projects based on that core. A core file is the collection point for components available for a project to be built against that core. A core component file describes how to incorporate and implement a component into a project. For example, a core component file can store information including, but not limited to, from where source files can be retrieved, to where source files can be delivered, how a file will be compiled/interpreted/executed, and other rules/actions that need to happen on behalf of a core component when a project is built. Example components include, but are not limited to, a boot loader, an original equipment manufacturer (OEM) adaptation layer (OAL), and a device ware component (e.g., collection of device drivers).

A project uses a core file and the core file in turn uses core component files. In an environment processed by the systems and methods described herein, there may be N core files (e.g., core file 210 through core file 230) where each core file has a list of available component files. Similarly, there may be M core component files from which the N core files can select available core components. By way of illustration, a first core file 210 may list a first core component file 240 and a second core component file 250 as being available for a project. When a project selects the first core file 210, a rule and/or an environment parameter may determine to include the first core component file 240 with the project and to not include the second core component file 250. Similarly, a second core file 220 may list the second core component file 250 and an Mth core component file 260 as being available for a project. When a project selects the second core file 220, a rule and/or an environment parameter may determine to include the Mth component file 260 with the project and to not include the second core component file 250. In some cases, a link to a source file associated with the selected core component file is placed in the project build directory while in other cases the core source file is copied into the project build directory.

Sets of core files may be aggregated for various collections of projects. For example, core files 210 through 230 may be aggregated into a collection ASICORE.CLD associated with Intel StrongARM processors. Similarly, sets of core component files may be aggregated. For example, core component files 240 through 260 may be aggregated into a collection WINCE.CLD associated with the Microsoft Windows CE operating system. The aggregations of core files and core component files can then be distributed, for example, on computer readable media to facilitate building a computer executable project. The files stored in the aggregations may be stored in a generic yet customizable manner that facilitates reusing the code. For example, a section of a file may have instructions relevant to various versions of an operating system. Thus, when the version of the operating system is determined, the shareable, reusable code can be customized based on that version, relevant instructions can be retained and irrelevant instructions can be excised from the file.

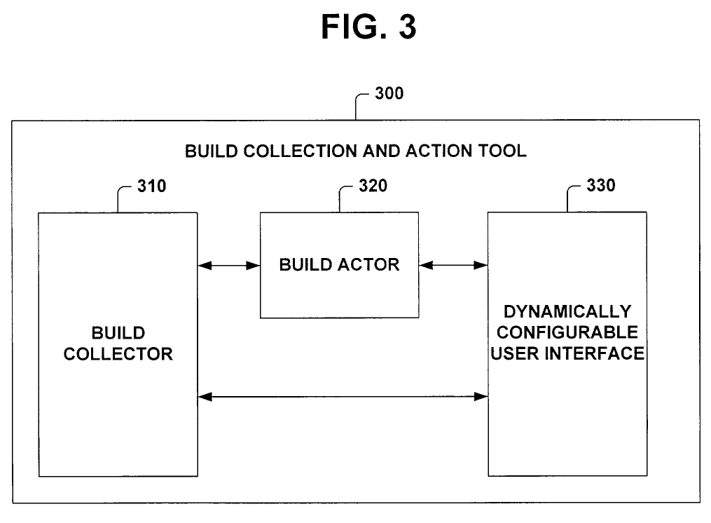

FIG. 3 illustrates an example tool 300 that facilitates collecting files from a shareable, reusable code base, customizing collected files and for making build choices related to the collected files. The tool 300 is a computer component. In one example, the tool 300 facilitates building Windows CE systems for various internet appliances based on the Intel StrongARM processor platform. The tool 300 includes a build collector 310 that facilitates collecting files and build rules, building a project build directory, and populating the project build directory with appropriate files and/or links. The build collector 310 is a computer component. The build collector 310 may collect files in various way including, but not limited to, a debug mode, a release mode, a binary release mode, a source release mode, a mixed release mode, and so on. The files and build rules can be retrieved from locations including, but not limited to, a local disk, a remote disk, a local processor, a remote processor, the Internet, a version controlled source database, a version controlled executable database, a process, a script, and so on.

The build collection and action tool 300 also includes a build actor 320 that can interact with either the build collector 310 and/or a dynamically configurable user interface 330. The build actor 320 applies build rules to the files collected by the build collector 310 to facilitate producing a build project directory. For example, the build actor 320 may apply rules to determine which of the collected files to compile, interpret, execute, link, and so on. Furthermore, the build actor 320 may employ rules to determine in which order the actions should be taken and where the results of the actions should be stored. Build rules employed by the build actor 320 can be stored in locations including, but not limited to, a core file, a core component file, a core source file, a third party component file, a project file, a project specific component file, and a project specific source file. Rules employed by the build actor 320 may also be generated by processes invoked by the build actor 320 during run time. By way of illustration, a first build action may result in a requirement for a second build action, where the second build action can not be determined until after the first build action is completed. Thus, the build actor 320 may select between second build actions based on the result of first build actions. The rules can be partitioned, for example, on environment parameters associated with a project. For example, rules may be classified by CPU type, motherboard type, operating system type, operating system version, communication bandwidth desires, and so on. However, rules can also be aggregated into master rules for larger aggregations of environment parameters. For example, a first operating system may require a first chip set and thus the operating system and chip set can be aggregated into a master rule for that chip set. Similarly, while various versions of an operating system may require a change in a subset of source files for a computer executable project, the various versions may share a common set of source files. Thus, the common files can be collected and/or processed according to a master rule for that operating system. The build actor 320 can be, for example, a computer component.

The build collection and action tool 300 also includes a dynamically configurable user interface 330. In one example, the user interface 330 is a graphical user interface that is context sensitive to a project. For example, a project may have a set of environment parameters that lead to only a certain set of source files from the reusable code base being relevant to building that project. Thus, the user interface 330 can dynamically configure itself to display information associated with the relevant files and to not display information associated with irrelevant files, which mitigates problems associated with too much information being presented in conventional systems. Similarly, the user interface 330 can determine from a project that only certain build rules are relevant to building a project. Thus, the user interface 330 can dynamically configure itself so that relevant combinatorial choices and rules are presented, again mitigating problems with information overload associated with conventional systems. Thus, the build experience for the project builder is improved because the builder is presented with a relevant subset of the build data and is not presented with irrelevant data and choices. In this way, the set of build information to which a builder is exposed is distilled down to the information that an experienced builder would consider relevant, providing fewer opportunities for the inexperienced builder to make mistakes, thereby improving the build experience.

The user interface 330 can dynamically configure itself based on project parameters including, but not limited to, operating system, central processing unit(s), computing platform, networking platform, communication platform, interface platform, and versions thereof, for example. By way of illustration, when a project is being built for an internet appliance that includes an Intel StrongARM processor, there is limited value in displaying files or choices associated with a Motorola processor that is not part of the appliance. Similarly, when a project is being built for an internet appliance that will run the Linux operating system, there is little value in displaying files or choices associated with the Windows CE operating system. Thus, a user attempting to build a computer executable project that includes shareable, reusable code will be presented with less information and fewer choices. Furthermore, the information and choices should be more relevant to building the computer executable project than is possible conventionally.

In one example, an interfacing method is employed on a computer system that has a graphical user interface. The GUI includes a display and a selection device. The method facilitates providing and selecting from a set of data entries related to sharing reusable code displayed on the display. The method includes retrieving a set of data entries, where the data entries represent items including, but not limited to, a core logic data, a core logic operation, a project specific data, a project specific logic operation, a third party data, and/or a third party logic operation. The method also includes displaying the set of entries on the display, receiving a data entry selection signal indicative of the selection device selecting a selected data entry, and in response to the data entry selection signal, initiating an operation associated with the selected data entry. For example, the dynamically configurable user interface may determine that based on a project environment, a first set of five build action rules are relevant to a first set of seven collected files. Thus, the display may present the five rules and for each of the five rules may present the set of collected files to which the rules apply. Thus, the person tasked with building the computer executable project that includes shareable, reusable code will select from relevant rules as applied to relevant files, mitigating problems associated with conventional systems and information overload.

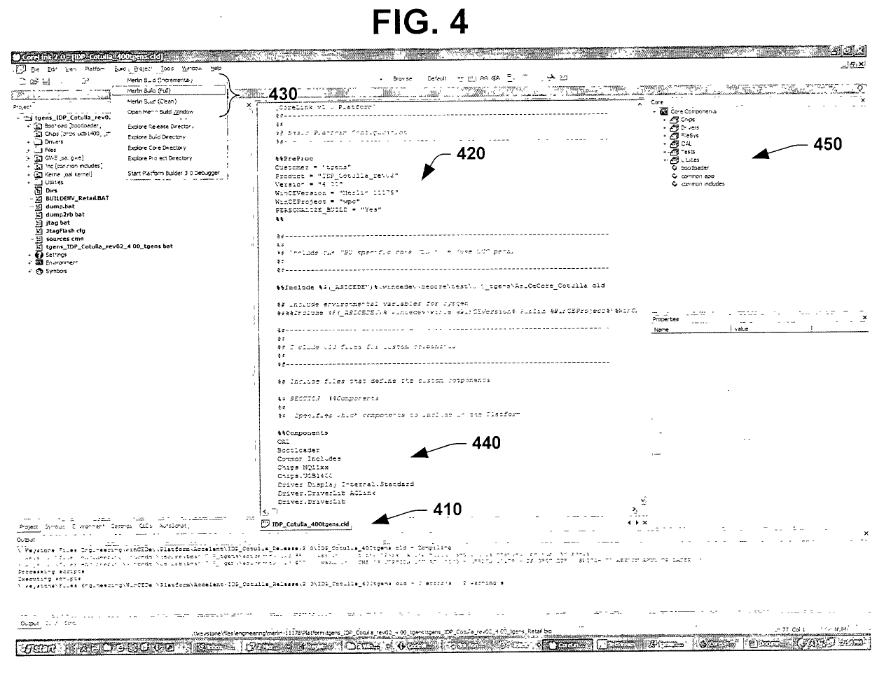

FIG. 4 is a screen shot of an example GUI associated with systems and methods for sharing a reusable code base. In FIG. 4, information associated with a project that is employing a core link definition (CLD) file IDP_Cotulla_400tgens.cld is illustrated. The file is identified at tab 410. Text associated with the core link definition file is illustrated in the center of FIG. 4, and at 420, the version of the operating system WinCEVersion=“Merlin.11176” is illustrated. Based, at least in part, on the operating system version identified at 420, menu entries 430 are dynamically configured to provide relevant choices for the user of the interface illustrated in FIG. 4. While a specific file (e.g., IDP_Cotulla_400tgens.cld) formed in a text manner is illustrated, it is to be appreciated that other files formed in other manners (e.g., XML) can be employed in accordance with the systems and methods described herein.

The CLD includes entries 440 for components available for the project. Graphical user interface icons and text are displayed at 450 to facilitate understanding which components are available for the actions for which menu entries appear at 430. The CLD file illustrated shows a build menu for an Intel PXA250-based hardware platform targeting a Microsoft Pocket PC 2002 (Merlin) project. While entries associated with one specific hardware platform and operating system are illustrated, it is to be appreciated that other CLD files can store information associated with other hardware and operating system combinations.

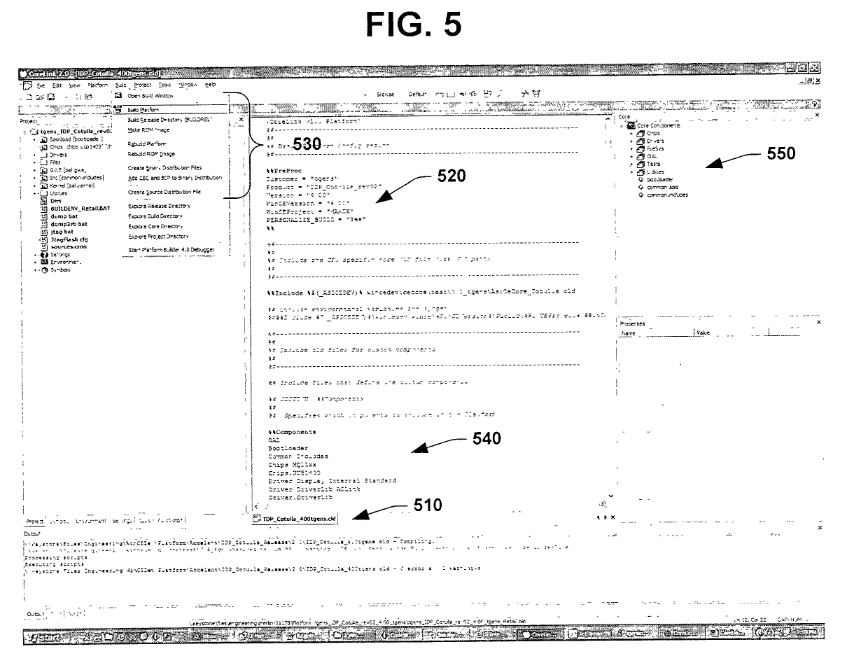

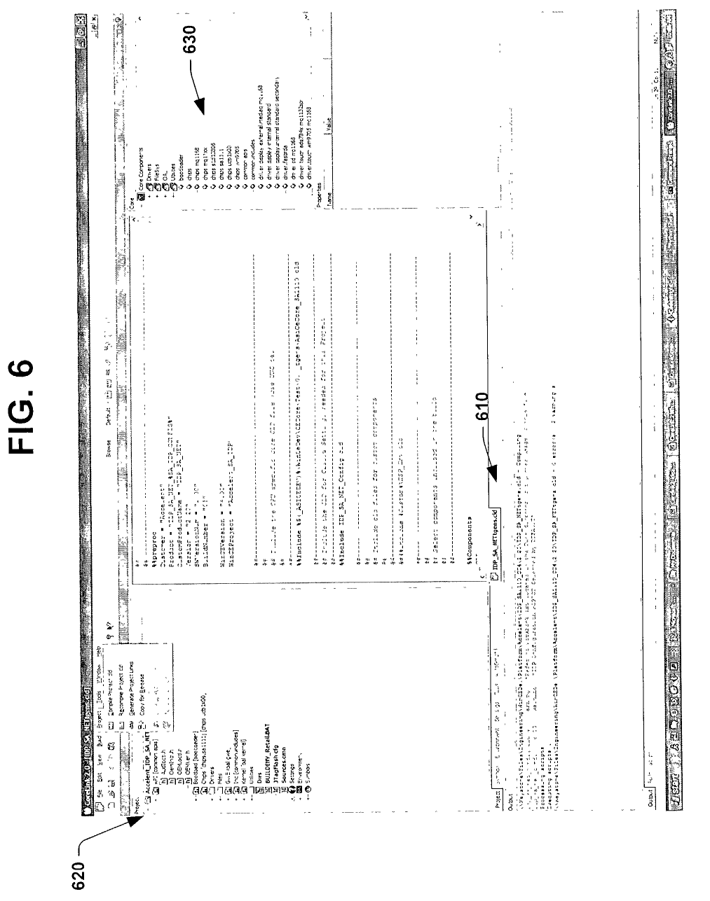

Thus, FIG. 5 is a screen shot of an example GUI associated with systems and methods for sharing a reusable code base where the hardware is the same as in FIG. 4, but the operating system version is different. Based, at least in part, on the operating system change, the type of information displayed and menus associated with that information are dynamically configured by the graphical user interface. In FIG. 5, information associated with a project that is employing a CLD file IDP_Cotulla_400tgens.cld is illustrated. The file is identified at tab 510. Text associated with the core link definition file is illustrated in the center of FIG. 5, and at 520, the version of the operating system WinCEVersion=“4.00” is illustrated. Based, at least in part, on the operating system version identified at 520, menu entries 530 are dynamically configured to provide relevant choices for the user of the interface illustrated in FIG. 5. Note that while the same CLD file is used for both projects, and that the projects are destined for the same hardware platform (e.g., Intel PXA250), that the menu 530 is different than the menu 430 (FIG. 4). The differences occur because the graphical user interface is able to determine which actions are relevant to building each project and, based on the determination, to display relevant entries to the user of the graphical user interface. While FIG. 4 and FIG. 5 share a hardware platform, FIG. 6 illustrates a screen shot of the example GUI when an internet appliance is being built on a different hardware platform, the Intel SA-1110.

At 610, a different file IDP_SA_NETtgens.cld is identified. Thus, because a different CLD file is being used, a different set of components are available at 620 and 630 than were available for the hardware platforms of FIG. 4 and FIG. 5. Additionally, although there may be common components between the platforms, various components may be configured differently due to the platform. Furthermore, common components may have different build rules (e.g., compile actions) based on the platform.

The operating system version WinCEVersion=“4.00” is the same as for FIG. 5. While two processors and two operating systems are described in connection with FIGS. 4-6, it is to be appreciated that the systems and methods described herein can be employed with various platforms, operating systems, and other project environment parameters.

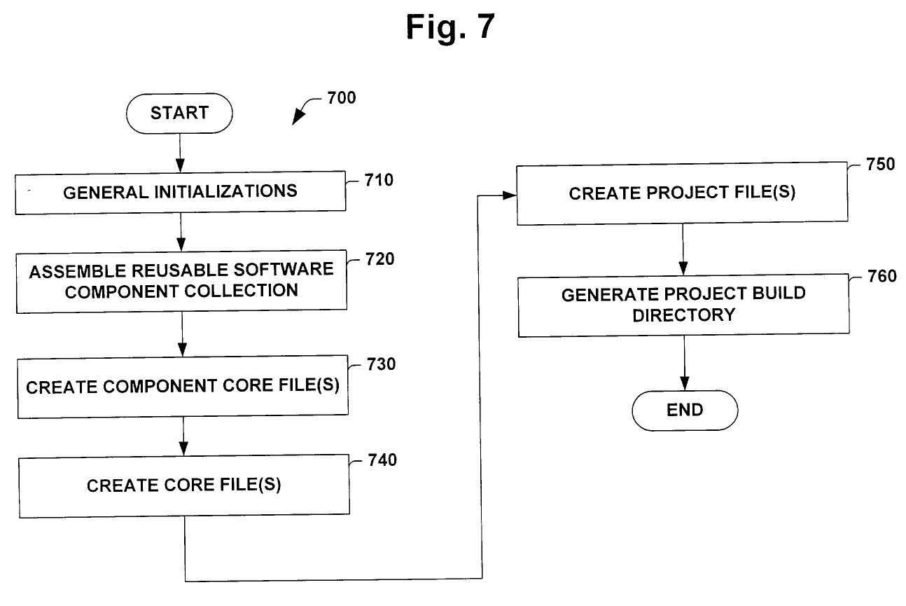

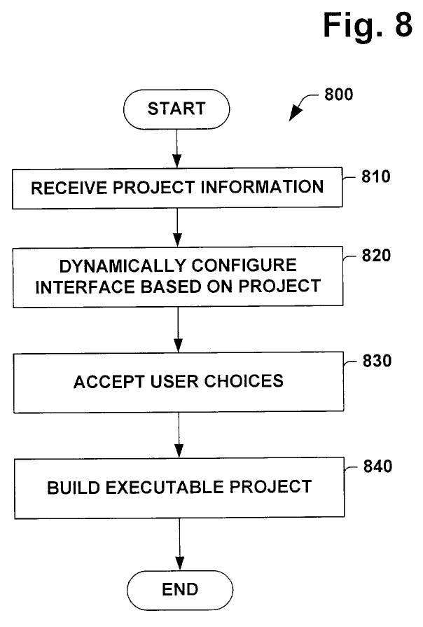

In view of the examples shown and described herein, example methodologies for sharing reusable code will be better appreciated with reference to the flow diagrams of FIGS. 7 and 8. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as computer executable instructions and/or operations stored on computer readable media including, but not limited to, an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick.

In the flow diagrams, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, the processing and decision blocks can be implemented in functionally equivalent circuits like a digital signal processor (DSP), a field programmable gate array (FPGA), an application specific integrated circuit (ASIC), and the like.

A flow diagram does not depict syntax for any particular programming language, methodology, or style (e.g., procedural, object-oriented). Rather, a flow diagram illustrates functional information one skilled in the art may employ to program software, design circuits, and so on. It is to be appreciated that in some examples, program elements like temporary variables, routine loops, and so on are not shown.

FIG. 7 is a flow chart that illustrates an example computer-based method 700 that facilitates reusing a shareable code base. At 710, general initializations occur. Initializations can include, but are not limited to, allocating memory, establishing pointers, establishing data communications, acquiring resources, setting variables and displaying process activity. At 720, reusable software components are assembled (assemble as used in this paragraph means to collect, not to transform assembly language instructions into executable code) into a collection of reusable software components. While the collection of software components may be stored, for example, in one location as a core of components, it is to be appreciated that software components may also be stored, for example, in a project file and/or be distributed between various data stores.

At 730, a component core file that facilitates selecting a reusable software component for use in building a project build directory is created. By facilitating selecting a reusable software component, the component core file in turn facilitates sharing reusable code, providing advantages over conventional systems where such reuse is not facilitated. In one example, there is one component core file for each software component in the collection. Like a project file may store a software component, so too, in one example, may a project file store a component core file. The component core file also facilitates customizing, for example, genericized multi-platform device drivers.

At 740, a core file is created. A core is a specific set of components from the collection. The set is suitable for some class of projects. The core includes rules common to projects based on the core and/or components within the core. The core file facilitates storing associated sets of available core component files. For example, a set of device drivers may be available to support platforms built with members of a chip set. Since projects built on the platform that employs the chip set are likely to require a similar set of device drivers, a core file can be built that aggregates the set of device drivers to facilitate selecting between the available drivers. When a driver is selected, it may be customized based on project specific information.

The core file also facilitates selecting reusable software components for use in generating a project build directory. Furthermore, the core file also facilitates storing associated sets of core level project build rules. Given a known set of device drivers for a chip set, the build rules for various combinations of the device drivers can be determined and stored in the core file. This facilitates customizing, for example, a device driver for a specific chip or chip set. Thus, the task of a person building a project from the device drivers is simplified by having the various combinatorial and/or customization rules determined in advance. While this paragraph discusses device drivers, it is to be appreciated that other types of files that are not device drivers may also be processed according to method 700.

At 750, a project file is created. The project file facilitates identifying items including, but not limited to, a core file, a component core file, a project specific component, a core level build rule, and a project specific build rule for use in building a computer build directory. The project file can specify, for example, the core, the set of components within the core used by a project, and project specific rules and components. Furthermore, the project file can identify environment parameters that are used to select, for example, files to collect and build actions to take.

At 760, a project build directory is generated. A build tool can be executed to generate the project build directory. The build tool can load a project file, examine project specific data (e.g., environment parameters), determine which files to collect, determine which build rules to apply, and invoke various compilers, assemblers, interpreters, link editors, and so on to process source files into software components. The source files, rules, software components, and/or links to these items can then be stored in the project build directory.

While FIG. 7 illustrates a linear flow, it is to be appreciated that during typical testing and debugging cycles that various blocks and/or sets of blocks may be repeated.

FIG. 8 is a flow chart that illustrates a portion of an example computer-based method 800 that facilitates reusing a shareable code base. At 810, project information is received. The project information may be, for example, project build directory information, project file data, and so on. At 820, a user interface is dynamically configured based, at least in part, on the project information received at 810. Unlike conventional systems that are human configured based on intuition concerning a project or person using a project building tool, the interface can self-configure based on the project. Thus, a person using the interface that dynamically self-configures at 820 can be presented with a more focused set of more relevant collection and/or build action choices than is possible conventionally. Thus, the build experience is enhanced and simplified.

At 830, the method accepts a user choice concerning collection choices and/or build action choices. The interface can accept the choices using, for example, a graphical user interface, a voice controlled interface, a haptic interface, and so on. At 840, based, at least in part, on the project information, the user choices, the collected files, and the available build rules, a computer executable project is built. Building the computer executable project may require launching one or more processes necessary to produce the final executable output. The processes may, in one example, involve customizing a source file based on project specific information. For example, various #ifdef statements may be executed to select portions of a file for compilation.

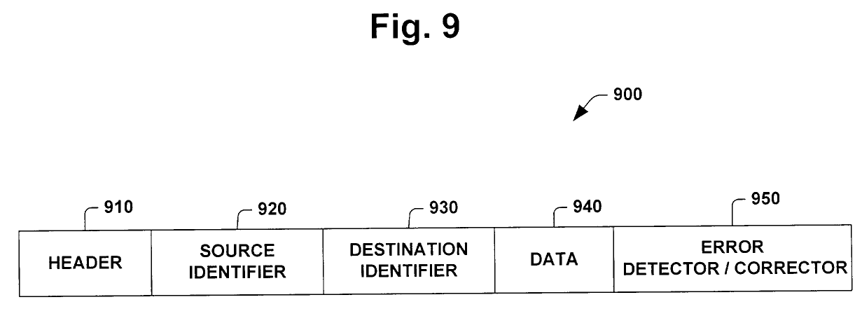

Referring now to FIG. 9, information can be transmitted between various computer components associated with systems and methods that facilitate reusing a shareable code base described herein via a data packet 900. An example data packet 900 is shown. The data packet 900 includes a header field 910 that includes information such as the length and type of packet. A source identifier 920 follows the header field 910 and includes, for example, an address of the computer component from which the packet 900 originated. Following the source identifier 920, the packet 900 includes a destination identifier 930 that holds, for example, an address of the computer component to which the packet 900 is ultimately destined. Source and destination identifiers can be, for example, globally unique identifiers, URLS (uniform resource locators), path names, and the like. The data field 940 in the packet 900 includes various information intended for the receiving computer component. The data packet 900 ends with an error detecting and/or correcting field 950 whereby a computer component can determine if it has properly received the packet 900. While six fields are illustrated in the data packet 900, it is to be appreciated that a greater and/or lesser number of fields can be present in data packets.

The data field 940 can store, for example, information associated with transmitting build file information and build logic. Thus, the data field 940 may include, for example, a first field that stores one or more source file identifiers and a second field that stores one or more source file combination rules. The source file identifiers can be employed to locate source files and the source file combination rules can be employed to determine how to combine the located source files into a compute executable project.

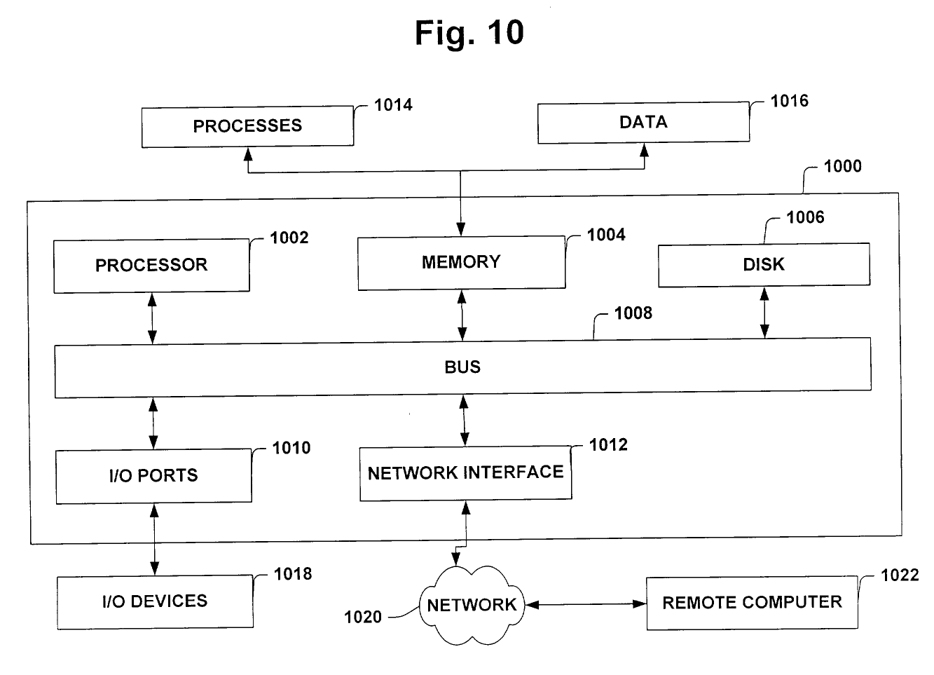

FIG. 10 illustrates a computer 1000 that includes a processor 1002, a memory 1004, a disk 1006, input/output ports 1010, and a network interface 1012 operably connected by a bus 1008. Executable components of the systems described herein may be located on a computer like computer 1000. Similarly, computer executable methods described herein may be performed on a computer like computer 1000. It is to be appreciated that other computers may also be employed with the systems and methods described herein.

The processor 1002 can be a variety of various processors including dual microprocessor and other multi-processor architectures. The memory 1004 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 1006 can include, but is not limited to, devices like a magnetic disk drive, a floppy disk drive, a tape drive, a Zip drive, a flash memory card, and/or a memory stick. Furthermore, the disk 1006 can include optical drives like, compact disk ROM (CD-ROM), a CD recordable drive (CD-R drive), a CD rewriteable drive (CD-RW drive) and/or a digital versatile ROM drive (DVD ROM). The memory 1004 can store processes 1014 and/or data 1016, for example. The disk 1006 and/or memory 1004 can store an operating system that controls and allocates resources of the computer 1000.

The bus 1008 can be a single internal bus interconnect architecture and/or other bus architectures. The bus 1008 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 1000 interacts with input/output devices 1018 via input/output ports 1010. Input/output devices 1018 can include, but are not limited to, a keyboard, a microphone, a pointing and selection device, cameras, video cards, displays, and the like. The input/output ports 1010 can include but are not limited to, serial ports, parallel ports, and USB ports.

The computer 1000 can operate in a network environment and thus is connected to a network 1020 by a network interface 1012. Through the network 1020, the computer 1000 may be logically connected to a remote computer 1022. The network 1020 includes, but is not limited to, local area networks (LAN), wide area networks (WAN), and other networks. The network interface 1012 can connect to local area network technologies including, but not limited to, fiber distributed data interface (FDDI), copper distributed data interface (CDDI), ethernet/IEEE 802.3, token ring/IEEE 802.5, and the like. Similarly, the network interface 1012 can connect to wide area network technologies including, but not limited to, point to point links, and circuit switching networks like integrated services digital networks (ISDN), packet switching networks, and digital subscriber lines (DSL).

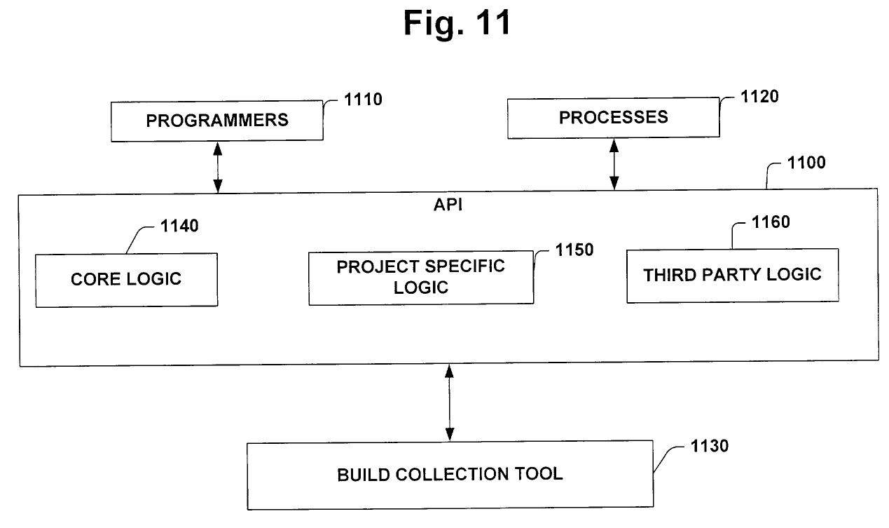

Referring now to FIG. 11, an application programming interface (API) 1100 is illustrated providing access to a tool 1130 that facilitates building computer executable projects and sharing a reusable code base. The API 1100 can be employed, for example, by programmers 1110 and/or processes 1120 to gain access to processing performed by the tool 1130. For example, a programmer 1110 can write a program to access the build collection tool 1130 (e.g., to invoke its operation, to monitor its operation, to access its functionality) where writing a program is facilitated by the presence of the API 1100. Thus, rather than the programmer 1110 having to understand the internals of the tool 1130, the programmer's task is simplified by merely having to learn the interface to the tool 1130. This facilitates encapsulating the functionality of the tool 1130 while exposing that functionality. Similarly, the API 1100 can be employed to provide data values to the tool 1130 and/or retrieve data values from the tool 1130. For example, a process 1120 that accesses core logic 1140 can provide data and/or control information to the tool 1130 via the API 1100 by, for example, using a write call provided in the API 1100. Similarly, a programmer 1110 concerned with project specific logic 1150 can receive data and/or control information from the build collection tool 1130 via the API 1100 by, for example, using a read call provided in the API 1100. Likewise, a process that monitors third party logic 1160 can interact with the tool 1130 via the API 1100.

Thus, in one example of the API 1100, a set of application program interfaces is stored on a computer-readable medium. The interfaces are executed by a computer component to access a build collection tool 1130. Interfaces can include, but are not limited to, a first interface that processes a first data associated with a core logic, a second interface that processes a second data associated with a project specific logic, and a third interface that processes a third data associated with a third party logic. The first, second, and third data facilitate collecting build files and build logic for building a computer executable project in a manner that facilitates sharing a reusable code base.

The systems and methods described herein may be stored, for example, on a computer readable media. The media can include, but are not limited to, an application specific integrated circuit (ASIC), a compact disc (CD), a digital versatile disk (DVD), a random access memory (RAM), a read only memory (ROM), a programmable read only memory (PROM), a disk, a carrier wave, a memory stick, and the like. Thus, an example computer readable medium can store computer executable instructions for facilitating building a computer executable project from shareable, reusable code. One example method includes assembling reusable software components into a collection of reusable software components, creating a component core file that facilitates selecting a reusable software component for use in building a project build directory, creating a core file that facilitates storing associated sets of available core component files and thus facilitates selecting and customizing reusable software components for use in building a project build directory. The core file also facilitates storing associated sets of core level project build rules. The method also includes creating a project file that facilitates identifying a core file, a component core file, a project specific component, a core level build rule and/or a project specific build rule for use in building a computer build directory. The method also includes creating a project build directory. In one example, the method further includes building a computer executable project from the project build directory. In another example, the method further includes dynamically configuring a user interface based, at least in part, on project specific information.

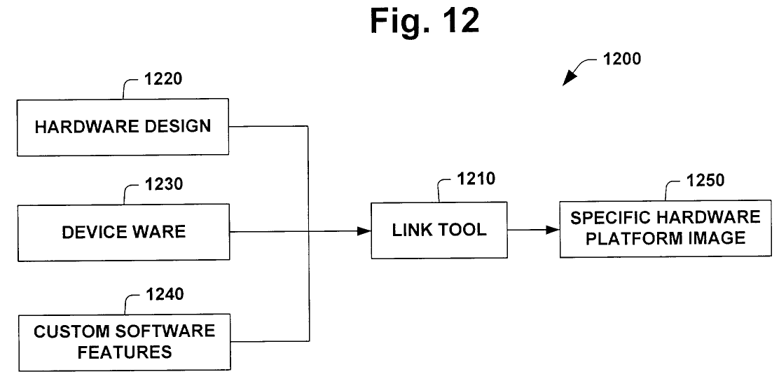

Turning now to FIG. 12, one example system 1200 that facilitates integrating operating system and application software combinations with board level components and hardware devices is illustrated. The system 1200 includes a link tool 1210 that receives inputs from a hardware design 1220, a device ware 1230, and custom software features 1240 and produces a specific hardware platform image 1250.

The hardware design 1220 relates to hardware elements included in, for example an internet appliance. For example, the hardware elements may include microprocessors, input/output ports, memory, displays, and so on. An internet appliance can be, for example, a personal digital assistant (PDA), a web pad, a portable data terminal (PDT), an E book, a gaming system, an internet audio/video device, an automated teller machine (ATM), a set-top box, a point of sale (POS) system, an internet kiosk, an industrial controller, and so on. In one example, the hardware elements relate to Intel StrongARM processors.

The device ware 1230 relates to a superset of highly configurable software and hardware modules designed for Internet appliance devices. The highly configurable software modules may be, for example, genericized, multi-purpose device drivers that can be customized for various platforms. In one example, the configurable software modules relate to the Microsoft Windows CE operating system.

The link tool 1210 thus facilitates building images for internet appliances like single board solutions with integrated processors and low power consumption. Example internet appliances may run Microsoft Windows CE and/or Linux on an Intel StrongARM hardware platform.

The following code segment illustrates a portion of an example project CLD file. The example file defines a software project that builds a Windows CE .NET operating system image for an integrated development platform. The operating system image will contain a custom OEM adaptation layer and a collection of custom device drivers specific to the device. The integrated development platform includes an Intel PXA250 processor, thus the project CLD file pulls in a related corresponding core CLD file AsiCeCore_PXA250.cld. The project CLD file also establishes a platform specific environment. While the example project CLD file is illustrated in a specific format and employing a specific syntax, it is to be appreciated that a project CLD file can employ other formats and syntax including, for example, XML code.

[image]

[image]

[image]

[image]

[image]

[image]

[image]

[image]

[image]

[image]

[image]

[image]

[image]

Those skilled in the art will recognize that the above example is but one example project CLD file formatted in one example format and using one example syntax and semantics. Those skilled in the art will recognize that other project CLD files can be built using other simmilar sections, programming languages, data definitions and so on. For example, the information contained in the above project CLD file could be programmed into an XML file. The following code segment presents an example Core CLD file. This particular Core file supports an ASI project for a Windows CE device based on the Intel PXA250 processor. It defines the set of components that would be available to such a project. Again, it is to be appreciated that this is but one example Core CLD file presented in one example format using one example syntax and semantics. It is to be appreciated that other core CLD files in other formats using other syntax and semantics can be employed in accordance with the systems and methods described herein.

[image]

[image]

[image]

[image]

[image]

[image]

This is an example of a CLD file that defines a single component. Rules for creating a component in a project's build directory tree and custom methods for building the component are contained within its CLD file. This particular CLD file defines a Multi-media Card driver for a device running Windows CE. Once again, it is to be appreciated that this is but one example simple component CLD file presented in an example format with example syntax and semantics. Other component CLD files can be produced in other formats with other example syntaxes and semantics. In one example, the CLD file can include XML code.

[image]

What has been described above includes several examples. It is, of course, not possible to describe every conceivable combination of components or methodologies for purposes of describing the methods, systems, computer readable media and so on employed in facilitating sharing a reusable code base. However, one of ordinary skill in the art may recognize that further combinations and permutations are possible. Accordingly, this application is intended to embrace alterations, modifications, and variations that fall within the scope of the appended claims. Furthermore, to the extent that the term “includes” is employed in the detailed description or the claims, it is intended to be inclusive in a manner similar to the term “comprising” as that term is interpreted when employed as a transitional word in a claim.

What is claimed is:

1. A system that facilitates sharing a reusable code base, comprising:
one or more core source files that can be processed into software components to be included in a computer executable project;
one or more core component files that facilitate identifying and customizing one or more core source files associated with a computer executable project;
one or more core files that facilitate identifying one or more core component files available to be associated with a computer executable project;
a project file that facilitates identifying one or more environment parameters associated with a computer executable project, where the environment parameters facilitate identifying at least one of, a core file, and a core component file to be associated with the computer executable project, the project file also facilitating identifying at least one of a project specific software component, a project specific environment parameter, and a project specific source file; and
a build collector for collecting one or more of, a core source file, a project specific source file, a core software component, and a project specific software component into a build collection.

2. The system of claim 1, comprising a build actor for managing creating the computer executable project from the build collection.

3. The system of claim 1, where a core source file stores at least one of, statements that can be compiled, statements that can be assembled, statements that can be interpreted, executable statements, and script statements.

4. The system of claim 1, where a core source file is a genericized, automatically customizable device driver.

5. The system of claim 1, where a core component file stores a build rule for a core source file associated with the core component file.

6. The system of claim 1, where a core file aggregates a build information and a build rule for a class of computer executable projects.

7. The system of claim 1, where a project file stores one or more core file portions, one or more core component portions, and one or more core source file portions.

8. The system of claim 1, where the build collector performs one of, copying a core source file to a build directory, and managing a link to a core source file in a project build directory.

9. The system of claim 1, where the build actor applies one or more build rules to a build collection to build the computer executable project.

10. The system of claim 1, comprising a project controlled, dynamically configurable user interface to facilitate selecting actions to be performed by one or more of the build actor and the build collector.

11. The system of claim 10, where the interface is a graphical user interface.

12. A computer readable medium storing computer executable components of the system of claim 1.

13. A computer readable medium storing computer executable components of the system of claim 2.

14. A computer readable medium storing computer executable components of the system of claim 10.

15. A computer executable method for facilitating building a computer executable project that incorporates shareable, reusable code, comprising:
assembling one or more reusable software components into a collection of reusable software components;
creating a component core file that facilitates selecting and customizing a reusable software component for use in populating a build collection;
creating a core file that facilitates storing associated sets of available core component files and thus facilitates selecting one or more reusable software components for use in populating a project build collection, the core file also facilitating storing associated sets of core level project build rules;
creating a project file that facilitates identifying at least one of, a core file, one or more component core files, one or more project specific components, one or more core level build rules, and one or more project specific build rules for use in populating a build collection; and
creating a build collection.

16. The method of claim 15, comprising dynamically configuring a user interface based on a project specific data.

17. The method of claim 16, where the project specific data is provided by one or more of, a project file, a core file, a component file, and a software component.

18. The method of claim 16, comprising managing building an executable project from the build collection.

19. The method of claim 15, comprising storing one or more reusable software components in a project file.

20. The method of claim 15, comprising storing one or more component core files in a project file.

21. The method of claim 15, comprising storing one or more core files in a project file.

22. The method of claim 15, where the one or more reusable software components are provided from one or more of, a local data store, a remote date store, the Internet, a text file, an object file, an executable file, and a script file.

23. The method of claim 15, where the one or more reusable software components are genericized, automatically customizable device drivers.

24. A computer readable medium storing computer executable instructions operable to perform the method of claim 15.

25. A computer readable medium storing computer executable instructions operable to perform the method of claim 18.

26. A data packet for transmitting build file information and build logic between computer components of systems and methods that facilitate sharing a reusable code base, the data packet comprising:
a first field that stores one or more source file identifiers of one or more source files located in a reusable code base; and
a second field that stores one or more source file combination rules for combining the one or more source files identified by the source file identifiers.

27. In a computer system having a graphical user interface comprising a display and a selection device, a method of providing and selecting from a set of data entries on the display, the method comprising:
retrieving a set of data entries, each of the data entries representing one or more of a core logic data, a core logic operation, a project specific data, a project specific logic operation, a third party data, and a third party logic operation;
displaying the set of entries on the display;
receiving a data entry selection signal indicative of the selection device selecting a selected data entry; and
in response to the data entry selection signal, initiating an operation associated with the selected data entry.

28. A set of application programming interfaces embodied on a computer readable medium for execution by a computer component in conjunction with building a computer executable project while using shareable, reusable code, comprising:
a first interface for accessing a core logic and core data;
a second interface for accessing a project specific logic and project specific data; and
a third interface for accessing a third party logic and third party data;
where one or more of the core logic, the core data, the project specific logic, the project specific data, the third party logic, and the third party data are employed in building the computer executable project from reusable, shared code.

29. A system that facilitates sharing reusable code, comprising:
means for identifying a project specific environment;
means for identifying a genericized, automatically customizable, reusable, shared software component;
means for collecting one or more genericized, automatically customizable, reusable, shared software components into a build collection;
means for collecting logic for combining the genericized, automatically customizable, reusable, shared software components in the build collection into an executable computer project; and
means for displaying information concerning one or more of the collected software components and the logic for combining the collected software components, where the display is dynamically customized based, at least in part, on the project specific environment.

30. A system that facilitates integrating operating system and application software combinations with board level components and hardware devices, comprising:
a link tool that receives an input from one or more of a hardware design, a device ware, and custom software features; and
a build tool that produces a specific hardware platform image from one or more automatically customizable files stored in a shareable, reusable code base, where the image depends, at least in part, on one or more of the hardware design, the device ware, and the custom software features.

31. The system of claim 30, where the specific hardware platform image runs on an Intel StrongARM computing platform.

32. The system of claim 30, where the specific hardware platform image runs the Windows CE operating system.

33. The system of claim 30, where the specific hardware platform image runs the Linux operating system.
